(19) United States
(12) Patent Application Publication
(10) Pub. No.: US 2005/0049005 A1
(43) Pub. Date: Mar. 3, 2005

(54) Mobile telephone with enhanced display visualization

(76) Inventors: Ken Young, Vancouver (CA); Patrick Wong, Vancouver (CA); Milan Patel, San Marcos, CA (US)

Correspondence Address: Stephen J. Wyse;Scheef & Stone, L.L.P., Suite 1400, 5956 Sherry Lane, Dallas, TX, 75225, US

(21) Appl. No.: 10/651,484

(22) Filed: Aug. 29, 2003

(51) Int. Cl. H04B 7/00

(52) U.S. Cl. 455/566; 455/41.3

(57) ABSTRACT

A mobile telephone for displaying graphically enhanced images. The mobile station has a display for displaying images as directed by a processor. At the user's request a displayed image will be graphically enhanced using an algorithm that takes into account audio inputs being received by the mobile station, either though its normal voice microphone or though another dedicated to this function. The audio input may also be input received previously and stored, and may have been received from another device for the purpose of sharing the visualization experience. The graphically enhanced image is displayed for the user's entertainment and changes as the audio input changes. The image itself may have been captured by the mobile station if it is capable of doing so, or it may have been received over the Internet or another network, or selected from a collection stored on the mobile station itself.

### FIELD OF THE INVENTION

The present invention relates generally to the field of mobile telephony, and more particularly to an apparatus and method for displaying expressive graphics using the display on a mobile telephone.

### BACKGROUND OF THE INVENTION

Mobile telephones are now commonly used by an ever-increasing segment of the population. Originally the province of the wealthy, or those whose professions demanded access to mobile telephony, mobile phones are now widely available and affordable to most if not all consumers. Several factors have contributed to this phenomenon.

First and foremost, of course, are the technological advancements that have enabled mobile phone manufacturers to build and sell the telephones at lower cost. The electronic components needed for their operation are now relatively inexpensive and easy to obtain from a number of sources. At the same time, these technological advancements have enabled the development of smaller components. This not only means that the instruments themselves are more compact and easier to carry around, but also that they use less power, and so do not require large and cumbersome batteries that need frequent recharging.

Secondly, the technology of network communications has also improved. A mobile telephone is, generally speaking, a portable radio that communicates with a wireless telephone network using a radio channel. The network includes dozens, even hundreds of base stations that are dispersed geographically across the network coverage area. Each base station has connected to it at least one radio antenna for communicating with nearby mobile telephones. The communication range defined by a given antenna is sometimes referred to as a ‘cell’, giving rise to the popular term ‘cell phone’.

Mobile telephones operating in a cell communicate with the cell's antenna (and sometimes those of adjacent cells). A special procedure called handoff is used to transfer communications with a given mobile telephone from one antenna to another as the mobile telephone travels from one cell to another. Cellular technology permits the operation of larger numbers of wireless network subscribers because the mobile telephones require only relatively low-power radio transmitters. As a result, the frequencies that are used to define communication channels can be reused in non-adjacent cells without causing interference. Valuable bandwidth resources are conserved.

Other developments in network technology include methods of facilitating access to a base station by numerous mobile telephones. For example, in frequency division multiple access (FDMA), the available bandwidth is divided into channels defined by a more narrow frequency range. In time division multiple access (TDMA) each frequency channel is divided into a number of time slots, the actual transmission channel being formed by a combination of a time slot and a frequency. This permits the transmission of much more information by using each frequency channel more efficiently. Code division multiple access (CDMA), on the other hand, uses a number of spreading codes to spread the signal to be transmitted across the entire available bandwidth (or a selected portion thereof). The spreading codes are unique and assigned to each subscriber, normally on an ad hoc basis. Multiple transmissions may thereby be sent simultaneously as each mobile station, using the assigned spreading code, detects only that signal in the transmission that it was intended to receive. Other techniques are being developed, all having the common goal of enabling more mobile telephones to more efficiently use a wireless network.

Naturally, permitting a large number of users access to a wireless network also means that the cost per user decreases. Individual subscribers therefore pay less for mobile telephone service, a fact that also has the effect of increasing the number of users as service becomes more affordable.

Other factors contributing to the popularity and widespread use of mobile telephones include increases in their functionality, that is, the number of uses to which they can be put. Originally designed for use simply as telephones, mobile phones basically included the ability to dial, initiate, and answer telephone calls. Because of their portable nature, such phones quickly developed other useful feature, such as displays for displaying a telephone number that has been dialed and, in some cases, a telephone number associated with an incoming call. These displays soon grew in size and capability to also present status indicators and other information (described in more detail below).

Mobile telephones were also eventually provided with the ability to store phone numbers for future use. This included traditional speed dialing, where a key (0-9) is associated with a telephone number and causes it to be dialed whenever that key is pressed immediately after another designated key (for example, “#”) or combination of keys. This leaves the user to remember the numbers associated with each key. Mobile phones with displays could, of course, display a series of numbers from which the subscriber could choose by scrolling through the choices and using a ‘select’ key of some kind when the desired number is displayed. Mobile phones also came to have enough memory that other information could be stored for later recall as well, such as a name and address associated with the stored number. From here, other features were added including electronic appointment calendars, logs of calls sent and received, and even games that could be played by the user when the telephone was not being used for an actual call.

The ability of wireless networks to carry data transmissions has also increased the usefulness of mobile phones, especially as wireless networks are connected to the Internet via gateway switches. Any data stored on the mobile telephone may be transmitted to and received by another mobile station though such a connection. Subscribers are able to send email to one another, and in fact to anyone else with a network connection. Many mobile telephones are now even capable of taking pictures, and can use their communication capability to send the images for viewing by others.

The demand for still more features continues, however, especially as mobile phones continue to gain popularity with an ever-widening segment of the population. From the point of view of manufacturers, the need to appeal to younger users is an important consideration. Not always needing their mobile phones for business, young customers are often more prone to use their phones for social interaction and entertainment. For this reason, they are frequently not satisfied with instruments that do little more than traditional telephones. On the other hand, they are more likely to repeatedly purchase new phones, or upgrades for existing ones, so that they are able to have access to the latest advances.

There is a need in the marketplace, therefore, for a mobile telephone offering additional features that entertain and facilitate socializing while taking advantage of the modem wireless network's expanded capabilities. The present invention provides just such a solution.

### SUMMARY OF THE INVENTION

In one aspect, the present invention is a mobile telephone, normally operable to communicate in a wireless telecommunication network, including a display for displaying images that can be viewed by the user, an audio input device for receiving audio input and supplying it to a processor, which applies a selected graphic enhancement algorithm to create a continually evolving image for display. The graphic enhancement typically includes selective distortion effects that vary the base image first displayed but not so that it is no longer recognizable. The graphic enhancement is a function of the audio input so that the user is presented with a graphically enhanced image that changes with the sounds the user is hearing.

The produced image may be viewed by the user alone, with others, or transmitted to others either at the user's present location or at a completely different one. The mobile station may also include a camera for capturing images to be graphically enhanced according to the present invention, and preferably includes as well sufficient memory to store captured images, graphically enhanced images, and a collection of algorithms for performing the enhancement, from which the user may select. In one embodiment, the memory also stores the audio input or inputs received so that the may be recalled later for listening or further graphic enhancement.

In another aspect, the present invention is a method of displaying an enhanced graphic image on a mobile telephone having a display coupled to a processor, including the steps of receiving and displaying a base image, receiving audio input, generating an enhanced graphic image by modifying the displayed image according to a graphic enhancement algorithm, wherein the image modification is a function of the received audio input, and displaying the graphically enhanced image on the display.

### BRIEF DESCRIPTION OF THE DRAWINGS

For a more complete understanding of the present invention, and the advantages thereof, reference is made to the following drawings in the detailed description below:

FIG. 1 is a front view of a mobile station that may be used to implement image graphic enhancement according to an embodiment of the present invention.

FIG. 2 is a reverse view of the mobile station of FIG. 1.

FIG. 3 is an illustration of the mobile station of FIG. 1 featuring a displayed image.

FIG. 4 is an illustration of the mobile station of FIG. 3 having a displayed image, but here as modified by a simple graphic enhancement algorithm.

FIG. 5 is a simplified block diagram illustrating the relationship between selected components of mobile station in accordance with an embodiment of the present invention.

FIG. 6 is a flow diagram illustrating a method of producing an enhanced graphic image according to an embodiment of the present invention.

### DETAILED DESCRIPTION

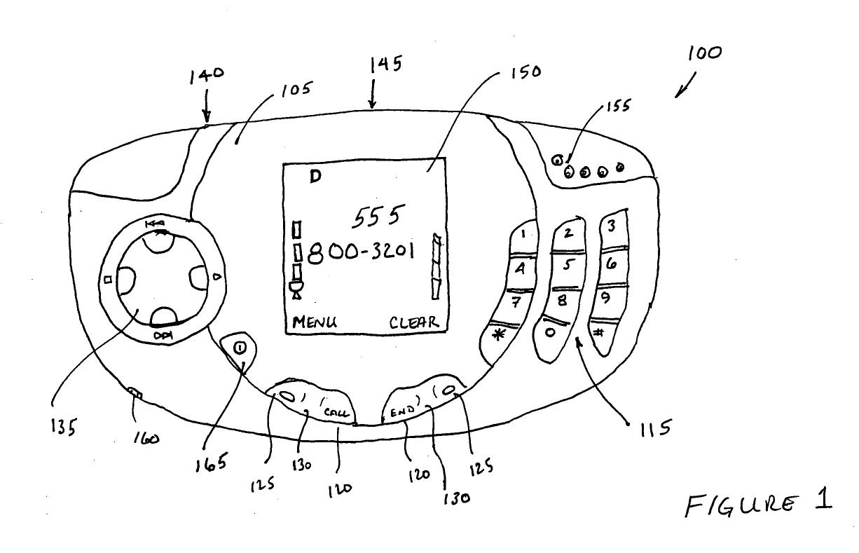

FIGS. 1-6, discussed herein, and the various embodiments used to describe the present invention are by way of illustration only, and should not be construed to limit the scope of the invention. Those skilled in the art will understand the principles of the present invention may be implemented in any similar radio-communication device, in addition to those specifically discussed herein.

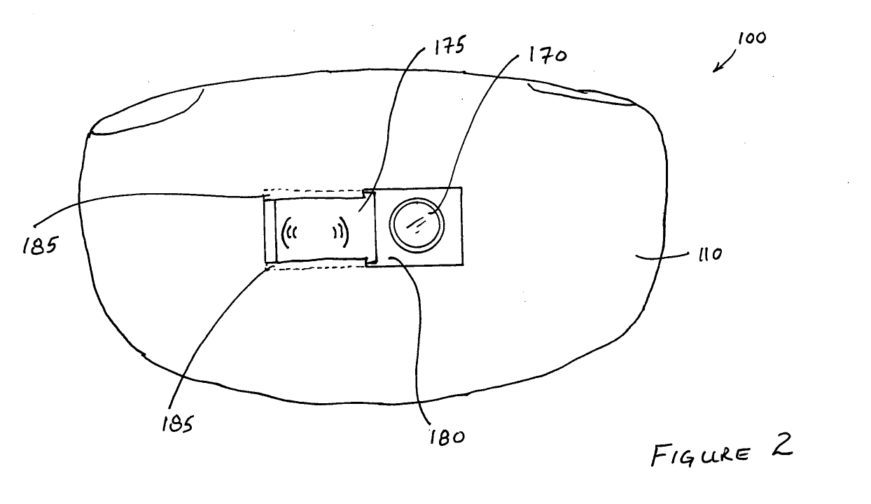

The present invention is directed to a mobile station with image graphic enhancement capabilities. FIG. 1 is a front view of a mobile station 100 that may be used to implement image graphic enhancement according to an embodiment of the present invention. Mobile station 100 includes a front cover 105 and a back cover 110 (shown in FIG. 2) that together form an enclosure for the mobile station's internal components (not shown). Numerous openings in front cover 105 permit operation of the externally accessible keys, which can be pressed by the user to activate switches that are part of the mobile station's internal components.

Among the keys available on the illustrated mobile station are alphanumeric keys 115, which may be used to enter, for example, a number to be dialed or the text of an SMS message. Call control keys 120 may be used to begin and end a telephone call or other operation in which the mobile station 100 is engaged. Function keys 125 are keys whose functions vary according to the current state of the mobile station. Note that in this embodiment, each call control key 120 and function key 125 are actually formed of a single rocker key 130, which may be depressed on one side or the other to activate the appropriate switch below. Navigation device 135 is likewise a single key, circular in shape, that activates any one of four or more switches depending on the area of its periphery that is depressed.

Also visible though an opening formed in front cover 105 of mobile station 100 is a display 150. Display 150 is a device for presenting visual information to the user, and is typically, though not necessarily, a liquid-crystal display (LCD) device. LCDs, and especially active-matrix LCDs, have evolved to the point where they are able to present even detailed images clearly. In FIG. 1, the display 150 is being used in connection with standard telephone operation. Visible is a telephone number that has been entered. To either side of the number are seen status indicators showing the strength of the signal that the mobile station is receiving from the base station and the battery charge condition, respectively. The labels visible at the bottom of display 150 are function key labels, and indicate to the user the operation that will be performed by either of function keys 125 if presently activated.

A plurality of openings formed in front cover 105 serve as a speaker port 155, allowing sound generated by an underlying speaker (not shown) to pass so that the user may hear it. Likewise, a microphone port 160 is formed to allow audio input to reach an internal microphone (also not shown). For telephone conversation this audio input will be the user's voice, and microphone port 160 is therefore located at the opposite end of mobile station 100 from speaker port 155, so that mobile station 100 may be held and used as a conventional telephone handset.

An alternative, and increasingly popular mode of operation involves the use of an external microphone and earpiece (not shown). These are typically connected to mobile station 100 using a cable having a connector for plugging into external device port 145. The cable is of sufficient length so that the user may set the mobile station aside and out of the way, even while in use, or hold it at a distance suitable for viewing the image being presented on display 150.

Power for mobile station 100 is ordinarily drawn from a battery (not shown), also disposed within the enclosure formed by front cover 105 and back cover 116. An on/off key 165 is provided for the user to turn the mobile station 100 on and off. Power port 140, however, provides for connecting to an external power supply as an alternate power source or to recharge the mobile-station battery.

FIG. 2 is a reverse view of the mobile station 100 of FIG. 1. Predictably, there are far fewer features visible from this perspective. In this embodiment, however, camera lens 170 is visible though an opening formed in back cover 110. Lens 170 focuses an image onto an image-capturing device, such as a charge coupled device. The captured image is then digitized and stored or transmitted, or both. Camera lens is protected when not in use by a sliding lens cover 175, mounted in recess 180 and held in place by slide rails 185, which extend into recess 180 from back cover 110 and exterior to lens cover 175.

Although not a traditional feature on telephones or mobile stations, integrated cameras (that is, image capturing devices) have proven both very useful and popular. A subscriber conversing on a mobile station may capture an image, for example, of another person, a building, and transmit it to another instead of (or in addition to) providing a verbal description. This can be for serious reasons such as documenting an accident scene or the commission of a crime, or for less serious events such as a chance meeting with an old friend. Especially with younger users, this has also become simply another form of communication, where two callers can share images of their surroundings and the people they encounter as they converse with each other.

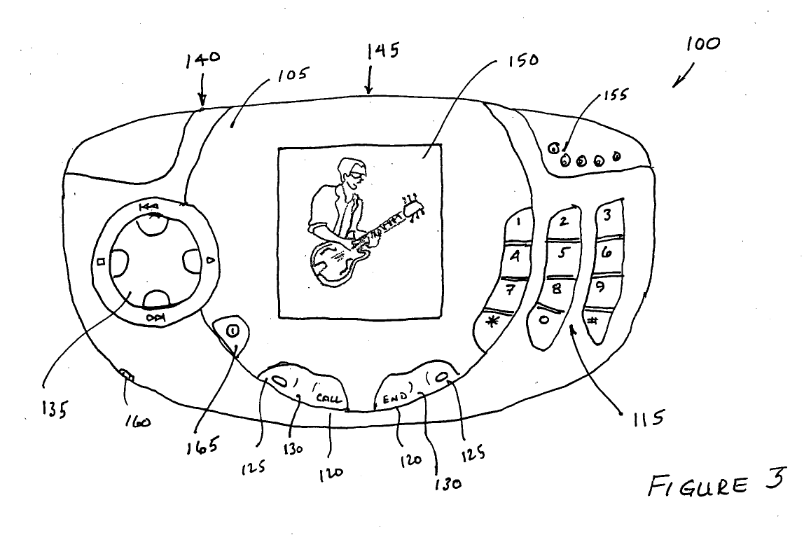

Captured images may be stored on a memory device of mobile station 100 to the extent that memory capacity is available. They may also be displayed on display 150 so that the user may view them, or decide whether to save, discard, or transmit them to someone else. FIG. 3 is an illustration of the mobile station 100 of FIG. 1 featuring a displayed image. If transmitted, the recipient of a transmitted image may be a mobile station or some other device capable of receiving image files. A user receiving such files may of course decide whether to view, save, or retransmit them.

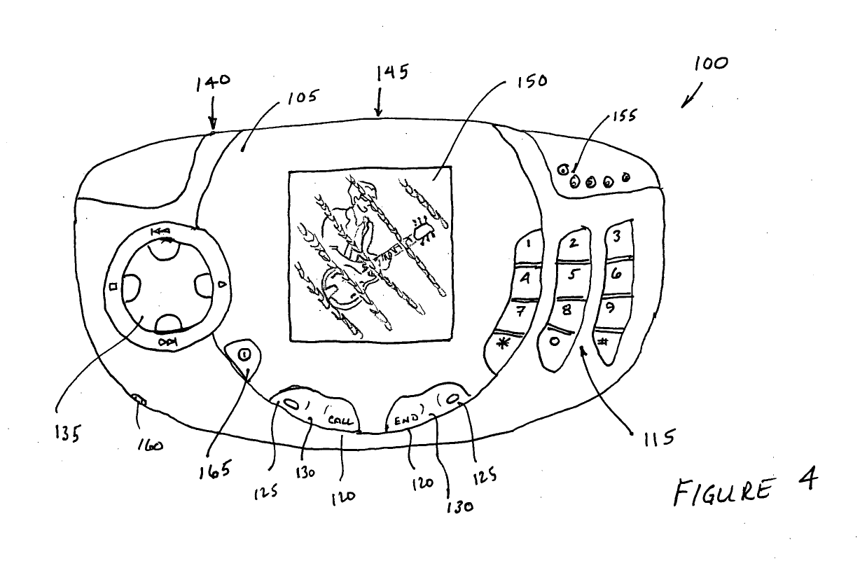

In accordance with an embodiment of the present invention, the subscriber may also elect to subject the image displayed on display 150 to graphic enhancement. A graphically-enhanced image is an image, captured or received, that is subjected to distortion effects caused, for example, by reprocessing the image with a stored algorithm. Generally, the distortion effects cause distortion that is minor and localized enough that the subject of the original image is recognizable. Simple examples include concentric-wave distortion that emulates ripples created in a pool of water, or selectively scrambling the pixels making up a relatively small area of the image. One example of this is shown in FIG. 4. FIG. 4 is an illustration of the mobile station 100 of FIG. 3 having a displayed image, but here as modified by a simple graphic enhancement algorithm.

Distortion effects may be static, in effect creating a new image, but may also be dynamic. In dynamic graphic enhancement, in other words, the distorting effects are programmed to produce a continually-changing image according to a certain recognizable pattern of distortion. The different patterns are preferable selectable by the user, who can alter their selection to find a pattern pleasing to them. The aesthetic impact of the graphically-enhanced image is, of course, subjective, but with sufficient available selection each user is able to choose from many algorithms in order to fit their taste and mood. In accordance with the present invention, the user may also be able to select an intensity level, that is, the amount of distortion that the base image will undergo according to the selected algorithm.

Preferably, however, the quality of the graphic enhancement is a function of the audio input received at the mobile station. Note that ‘quality’ includes changes to the graphic enhancement and, in a continually-changing enhancement, changes to the speed or intensity of change as well. For example, if a user at a concert captures an image of the musician and displays the image, it will begin as a more or less faithful representation of the scene the user is viewing. When graphic enhancement is selected and initiated, the displayed image begins to distort according to the algorithm selected; becoming wavy or hazy, for example. In one embodiment, the amount of distortion may begin to increase as the music starts and the mobile station receives audio input. Depending on the algorithm, the distorting effect of the graphic enhancement may increase or decrease with, for example, the volume, frequency range, or pitch of the music. Other audio inputs will have an impact as well, of course, such as noise from a passing automobile or even the sound of a nearby conversation.

While the graphic enhancement algorithm may use the audio input obtained from the same microphone used for voice communication, this input may be less than satisfactory. For one this microphone may be most ideally suited for sounds produced in the very near vicinity. For another, the mobile station may actually employ some form of noise cancellation (or similar function) in order to suppress ambient noise in favor of what is presumably the user's voice. As a result, in some cases the graphic enhancement may be more a function of spurious utterances near the mobile station than of the music or other event sounds. For clarity, these latter sounds will be referred to herein as ‘ambient’ sounds because they largely form the environment that the user is interested in visualizing (notwithstanding the fact they may originate farther from the mobile station than some undesirable sounds).

When this effect may occur, it may be preferable to have a second microphone available. This device could be integrated into the mobile telephone itself. If so, it could be switched on and off by the user, to be used in lieu of or in conjunction with the regular voice microphone. Alternately, the second microphone could be automatically switched on when the graphic visualization feature is activated. In yet another embodiment, a key could also be designated for the user to activate to switch back to the voice microphone when necessary to interject a discreet comment for recording or transmission, or simply to engage in ordinary conversation.

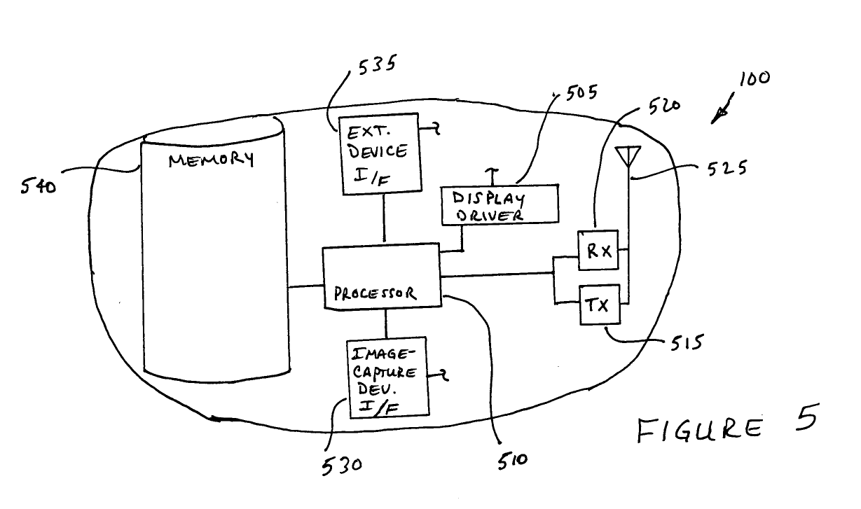

FIG. 5 is a simplified block diagram illustrating the relationship between selected components of mobile station 100 in accordance with an embodiment of the present invention. In the illustrated embodiment, mobile station 100 includes transmit circuitry 515 and receive circuitry 520 connected to antenna 525 for use in operation as a mobile telephone and also for use in accordance with the present invention. As such, transmit circuitry 515 and receive circuitry 520 will be able to transmit not only voice communications, but data such as encoded images and instructions for graphically enhancing them (that is, algorithms) as well. The transmit circuitry 515 and receive circuitry 520 are connected to a mobile station processor 510, which directs their operation.

Also connected to processor 510 is a display driver 505 for providing instructions to the display for creating an image. An image-capturing device interface 530 received input from the image capturing device itself and provides it to the processor 510 so that it can be display or stored. External device interface 535 is representative, that is, there may be a number of external devices such as external microphones (either for voice or ambient sound processing) or headphones. There may also be capability to connect, through an external device interface, to another mobile phone or similar device without using the radio transmitter or receiver, for example by using a cable.

Finally a memory device 540 is coupled to the processor 110. Memory device 540 (which may actually include more than one physical device) may be used for storing a mobile telephone directory, and may also in accordance with the present invention be used for storing images, whether captured, generated, or received from another, external device. It may also be used to store the algorithms that are used for graphic enhancement. Preferably, it also stores audio input received from various sources for future use in accordance with the present invention. For example, in one embodiment, the user may subsequent to an event such as a concert display images captured there and listen to the audio input for the concert. I this case, it may by preferable to also store cues indicating which algorithms were used for graphic enhancement in association with which audio input. New images may also be generated at the user's option, of course.

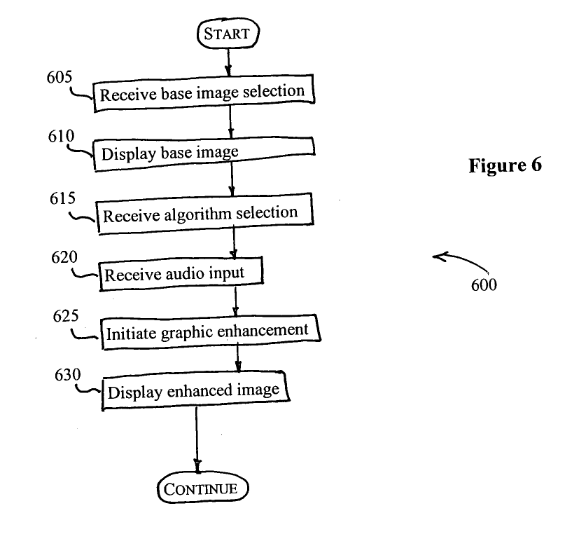

FIG. 6 is a flow diagram illustrating a method of producing an enhanced graphic image according to an embodiment of the present invention. At start, it is presumed that a mobile station such as mobile station 100 of FIG. 1 has been provided with one or more suitable algorithms from which the user may select. The process begins at step 605, where the mobile station 100, and specifically the processor 510 (or another processor assigned to this function), receives a base image selection. The base image is simply the one, selected by the user, that will be graphically enhanced in accordance with the present invention. The display driver 505 is then instructed to display the base image on the display 150 (step 610). Note that if no selection is made a default image may be used, such as the user's picture or a logo. A graphic enhancement algorithm selection is them received as it is input by the user (step 620), and audio input is received (step 620) after a similar selection (of the audio source). (Note that the image, algorithm, and audio may actually be selected in any order.)

The graphic enhancement of the base image is then initiated, either automatically upon reception of the selection criteria or at the entry of a command by the user (step not shown). Once initiated, of course, the distorted or modified image is displayed (step 630). The process continues with operation of the algorithm as a function of the received audio input, and the display 150 is continually refreshed with the revised images. Naturally, it is preferred that the user may adjust their selections at any time in the process, perhaps by invoking a menu that is superimposed on (or temporarily replaces) the displayed image, offering choices from which a selection may be made (step not shown).

The visualization created on the mobile station display by the base image processed with graphic enhancement is visually stimulating and compelling, and is expected to be especially popular with younger users that attend parties having music and many attendees. The selection of an image and a graphic-enhancement pattern allow the user to contribute their own imagination and creativity, while the actual operation of the graphic-enhancement feature provides spontaneous entertainment value. Since the final image viewed is a function of the ambient sounds, there is a connection between what the user is hearing and what they are seeing.

The graphic-enhanced images may be shared as well, adding to their appeal. The sharing may be done ‘head-to-head’ by viewing the same mobile station, or by remote sharing between users of different mobile stations. There are several ways in which users of different mobile stations can share an image. To begin with, the image may be captured by any one of them, or imported from another source. Other sources may include third-party mobile-station users, of course, or those with cameras that are able process a file for transmission to a mobile station. A remote server may be accessed through the Internet or some other network to obtained images stored there. If at an even such as a concert, the concert promoter may make images available either from a previously stored catalog or from the actual performance as it takes place.

Preferably, the mobile station is also capable of storing a plurality of previously captured or received images. In this case the user may select one using a menu system or from a sequence of images shown on the mobile station display one at a time.

Once obtained at a mobile station, the user then displays the image and selects a graphic-enhancement option. An on-screen menu superimposed on the base image is preferred for this operation because then the user does not have to switch back and forth between one screen and another. This configuration is also more convenient where selections are to be experimented with, so that the user can see their visualization effect then decide to accept it or to continue with another. In one embodiment, at the user's request the mobile station simply cycles at a predetermined rate through available choices until the user makes a selection. This may be all available choices or only those that the user has manually selected in the past.

At this point, the user has selected both the base image and a graphic enhancement algorithm or pattern. The graphic enhancement may then be initiated if it has not automatically begun as part of the selection process. Of course, the user may simply enjoy the presentation themselves. But if they wish to share with another they may elect to do that as well. One method of doing so is to simply establish a telephone connection with another user and transmit the image. To conserve network resources, the evolving image is not continually sent, but rather the base image along with the graphic-enhancement algorithm. The algorithm, which is essentially mobile-station-readable instructions for performing the graphic enhancement, may be sent in its entirety unless the recipient also has the same algorithm that may be invoked by a reference number or other standard signal.

In a similar manner, the image may be transferred from user to user via a cable designed to connect two or more users for this purpose, provided the mobile stations themselves are compatible with each other and with this method of communications. A short range radio communication protocol such as Bluetooth may also be implemented in capable mobile stations. Similarly, an infrared or other optical connection may be established for the purpose.

Note that when the base image and graphic enhancement algorithm are shared, users (two or more) at the same location will be viewing very much the same presentation, except perhaps for variations introduced by the use of different mobile stations having different displays, processors, and so forth. If desired, a synchronization signal could also be exchanged so that each of the different viewers of the presentation begin seeing the same graphic-enhancement at basically the same time.

Naturally, if the different users sharing the images are at different locations, the graphic enhancement for each will likely evolve quite differently because the audio inputs will not be the same. This may be acceptable, or an alternate form of sharing could be used. In this alternative, a user sends the base image (and identifies the algorithm) to another, and then at least for some time, sends also the audio input that is being used for effecting the graphic enhancement. Assuming comparable equipment, the presentations should therefore be very nearly the same except for the delay encountered in transmission.

It is also preferred that in addition to saving captured (or other-wise obtained) base images, the mobile station is also able to save images, typically snapshot images, of the evolving graphically-enhanced presentation. These images could be shared as well, and even used as the base image for another graphic-enhancement session. If enough still images are saved, they could be presented on the mobile station display in sequence, effecting a slide-show presentation. Naturally, there is a finite amount of storage available on the mobile station itself, but images could also be transmitted to a remote storage facility as well.

In another embodiment, the audio input is also recorded, and can be stored at the mobile station itself or at a remote server. When used for playback, of course, any image can be selected as the base image, but typically it would be an image from the event where the audio was recorded. A base image could even be flagged so that the user would be able to have the same image associated with same music or other audio input that it was during the actual event. Event promoters might also want to make a recording of the event available so that users could use it instead of audio stored on their own mobile stations.

The preferred descriptions are of preferred examples for implementing the invention, and the scope of the invention should not necessarily be limited by this description. Rather, the scope of the present invention is defined by the following claims.

1. A mobile telephone operable to communicate in a wireless telecommunication network, said mobile telephone comprising:
a display for displaying an image;
a processor coupled to the display for processing the image to produce a graphic enhancement effect applicable to the displayed image; and
an audio input device for receiving audio input and supplying it to the processor; wherein the graphic enhancement effect is a function of the supplied audio input.

2. The mobile telephone of claim 1, further comprising a memory device coupled to the processor for storing images to be displayed.

3. The mobile telephone of claim 2, wherein a user of said mobile telephone may choose an image stored in the memory device and select it for display.

4. The mobile telephone of claim 2, wherein the memory device is also operable to stored graphically enhanced images produced by the processor.

5. The mobile telephone of claim 1, wherein the display is also used to display information related to mobile-telephone communications.

6. The mobile telephone of claim 1, further comprising an image-capturing device coupled to the processor.

7. The mobile telephone of claim 1, further comprising a microphone for use in voice communication, wherein the audio input device includes the microphone.

8. The mobile telephone of claim 7, further comprising a second microphone for capturing ambient sounds, wherein the audio input device includes the second microphone.

9. The mobile telephone of claim 8, further comprising means for the user to select which of the microphone and the second microphone will provide audio input for use in producing the graphic enhancement.

10 The mobile telephone of claim 1, further comprising a memory device for storing audio input received from the audio input device.

11. The mobile telephone of claim 10, wherein the audio input device includes the memory device for storing audio input.

12. The mobile telephone of claim 1, wherein said mobile station is operable to share enhanced graphic images.

13. The mobile telephone of claim 12, wherein the sharing of the enhanced graphic images is performed using the wireless telecommunication network.

14. The mobile telephone of claim 12, wherein the sharing of the enhanced graphic images is performed using a short-range connection to a compatible device without the need to connect to the wireless telecommunication network.

15. A method of displaying an enhanced graphic image on a mobile telephone having a display coupled to a processor, said method comprising the steps of:
receiving an image for display;
displaying the received image on the display;
receiving audio input in the processor;
generating an enhanced graphic image by modifying the displayed image according to a graphic enhancement algorithm, wherein the image modification is a function of the received audio input; and
displaying the graphically enhanced image on the display.

16. The method of claim 15, wherein the steps of generating and displaying the enhanced graphic image are repeated continuously until the processor receives an instruction to stop.

17. The method of claim 15, wherein the mobile telephone comprises an image capturing device, and further comprising the step of capturing an image for display.

18. The method of claim 15, wherein the mobile telephone comprises a memory device, and further comprising the step of string at least one generated enhanced graphic image.

19. The method of claim 18, further comprising the step of transmitting a stored enhanced graphic image to facilitate sharing between a user of the mobile station and a user having a device for receiving the transmitted image.

20. The method of claim 15, further comprising the step of transmitting an image and an algorithm to facilitate sharing between a user of the mobile station and a user having a device for receiving the transmitted image.
